(19) United States
(12) Patent Application Publication
(10) Pub. No.: US 2002/0114034 A1
(43) Pub. Date: Aug. 22, 2002

(54) Split wave method and apparatus for transmitting data in long-haul optical fiber systems

(76) Inventor: Winston Way, Irvine, CA (US)

Correspondence Address: WILSON SONSINI GOODRICH & ROSATI, 650 PAGE MILL ROAD, PALO ALTO, CA, 943041050

(21) Appl. No.: 10/046,139

(22) Filed: Jan. 9, 2002

Related U.S. Application Data
(63) Continuation-in-part of application No. 09/575,811, filed on May 22, 2000.
(60) Provisional application No. 60/260,696, filed on Jan. 9, 2001.
(60) Provisional application No. 60/346,786, filed on Jan. 7, 2002.

(51) Int. Cl. H04J 14/02; H04B 10/04

(52) U.S. Cl. 359/124; 359/180

(57) ABSTRACT

A method is provided for transmitting optical signals in an optical communication system. An optical input is received that has a first data rate and is split into a plurality of sub-wavelengths. The plurality of sub-wavelengths are spaced sufficiently close in wavelength to provide a spectral efficiency of all the sub-wavelengths that is close to or greater than a spectral efficiency of the optical input. The plurality of sub-wavelengths are then combined.

### CROSS-REFERENCE TO RELATED APPLICATIONS

This application is a continuation-in-part and claims the benefit of Serial No. 60/260,696 filed Jan. 9, 2001, and is a continuation-in-part of Ser. No. 09/575,811 filed May 22, 2000, and is a continuation-in-part of Serial No. ______ filed Jan. 7, 2002 (Attorney Docket No. 26084-719), all of which applications are fully incorporated herein by reference.

### BACKGROUND OF THE INVENTION

1. Field of the Invention

The present invention relates generally to methods and systems for transmitting optical signals in long-haul optical communication systems, and more particularly to methods and systems that that split a standard ITU wavelength into several sub-wavelengths that can increase the optical signal transmission distance without using dispersion-compensation devices.

2. Description of Related Art

The current trend in long-haul telecom systems is to use optical transceivers with a transmission data rate higher than 10 Gb/sec. This is not only because the communication traffic increases drastically, but also a consequence of that most vendors' trunk equipment, such as routers, switches, and cross-connects, has gradually changed their interfaces to data rates ≧10 Gb/sec. However, it is understood that when the transmission rate in an optical fiber link is higher than 10 Gb/sec, various system penalties could occur. These include polarization-mode dispersion (PMD)- and chromatic dispersion-induced pulse broadening. F. Heismann, “Polarization Mode Dispersion: Fundamentals And Impact On Optical Communication systems”, European Conference of Optical Communications (ECOC'98), vol.2, pp.51-79, 1998). These system penalties can be so severe that a 1550 nm, 10 Gb/sec system can only transport less than ˜100 km, provided no dispersion compensation device is used.

A number of PMD compensation techniques have been proposed as in U.S. Pat. Nos. 6,130,766, and 5,949,560. Most techniques rely on polarization controllers and polarization beam splitters. There are also a number of chromatic dispersion compensation techniques such as using dispersion compensation fibers (DCFs), tunable linearly chirped fiber gratings and tunable nonlinearly chirped fiber gratings. “Dispersion Variable Fiber Bragg Grating Using a Piezo-Electric Stack”, Electron. Lett., vol.32, pp.2000-2001, 1996, and U.S. Pat. No. 5,982,963. DCFs introduce significant optical insertion loss and add-on cost. Fiber gratings, on the other hand, can only be effectively applied to a narrow wavelength region.

Another approach to reduce the effects of chromatic dispersion-induced penalties in ≧10 Gb/s systems is by using bandwidth-compressed modulation techniques. These techniques include optical single-sideband modulation, amplitude-modulated phase shift keyed (AM-PSK) duobinary, and multi-level signaling. “Optical Single Sideband Transmission At 10 Gb/s Using Only Electrical Dispersion Compensation,” J. Lightwave Technology, vol.17, No.10, October 1999, pp.17⁴2-1749 “Optical Duobinary Transmission System With No Receiver Sensitivity Degradation”, Electron. Lett., vol.31, pp.302-304, Feb. 1995, and “Multi-Level Signaling For Increasing The Reach of 10 Gb/s Lightwave Systems”, J. Lightwave Technology, vol.17, November 1999, pp.2235-2248. However, these techniques can at best increase the 10 Gb/s transmission system distance up to about 300 km.

There is a need for an optical communication system, and its method of use, that has an increased optical transmission distance. There is a further need for an optical communication system, and its method of use, that has an increased optical transmission distance without using dispersion-compensating devices. Yet there is another need for an optical communication system, and its method of use, that splits a standard ITU wavelength into several sub-wavelengths, without using dispersion-compensation devices or requiring more ITU wavelengths for transmission, in order to increase the optical signal transmission distance.

### SUMMARY OF THE INVENTION

Accordingly, an object of the present invention is to provide an improved long-haul optical communication system and its method of use.

Another object of the present invention is to provide an optical communication system, and its method of use, that has an increased optical transmission distance.

A further object of the present invention is to provide an optical communication system, and its method of use, that has an increased optical transmission distance without using dispersion-compensating devices.

Yet another object of the present invention is to provide an optical communication system, and its method of use, that splits a standard ITU wavelength into several sub-wavelengths in order to increase the optical signal transmission distance without using dispersion-compensation devices or requiring more ITU wavelengths for transmission.

These and other objects of the present invention are achieved in a method of transmitting optical signals in an optical communication system. An optical input is received that has a first data rate and is split into a plurality of sub-wavelengths. The plurality of sub-wavelengths are spaced sufficiently close in wavelength to provide a spectral efficiency of all the sub-wavelengths that is close to or greater than a spectral efficiency of the optical input. The plurality of sub-wavelengths are then combined.

In another embodiment of the present invention, a method is provided for transmitting optical signals in an optical communication system. An optical input is received that has a first spectral efficiency and is split into a plurality of sub-wavelengths. The sub-wavelengths have a combined spectral efficiency close to or greater than the first spectral efficiency. The sub-wavelengths are then combined.

In another embodiment of the present invention, a method is provided for transmitting optical signals in an optical communication system. An optical input with a first data rate is received and then split into sub-wavelengths. Each sub-wavelength is in a single ITU window. The sub-wavelengths are then combined.

In another embodiment of the present invention, a long haul optical communication system includes a first optical-to-electronic converter and a first electronic demultiplexer that are configured to receive and split an optical input into a plurality of sub-wavelengths. The optical input has a first data rate. A plurality of optical transmitters are coupled to the first electronic demultiplexer. The plurality of optical transmitters are configured to transmit the plurality of sub-wavelengths with a wavelength spacing that provides a spectral efficiency of all of the sub-wavelengths close to or greater than a spectral efficiency of the optical input. A first optical multiplexer or first coupler, and a second optical demultiplexer, splitter or OADM, are provided. A plurality of receivers are coupled to the optical demultiplexer or splitter.

In another embodiment of the present invention, a long haul optical communication system includes a first optical-to-electronic converter and a first electronic demultiplexer. An optical transmitter is included with a common optical carrier coupled to the first electronic demultiplexer. The optical transmitter is configured to modulate the common optical carrier by using demultiplexed electronic signals, and splits an optical input into a plurality of sub-wavelengths. The sub-wavelengths in combination have a spectral efficiency close to or greater than a spectral efficiency of the optical input. An optical demultiplexer or optical splitter and a second electronic multiplexer are included. A plurality of receivers are positioned to receive input from the optical demultiplexer or the optical splitter and produce an output that is coupled to the second electronic multiplexer.

### BRIEF DESCRIPTION OF THE DRAWINGS

FIG. 1 is a schematic diagram of one embodiment of a a long haul optical communication system of the present invention.

FIG. 2 is a schematic diagram of another embodiment of a a long haul optical communication system of the present invention that includes a single U-DWDM optical single-sideband modulation transmitter.

FIG. 3 is a schematic diagram of a multi-channel optical add-drop multiplexer (OADM) that is used in place of the optical splitter and optical filters of FIG. 2.

FIG. 4 is a schematic diagram of another embodiment of a a long haul optical communication system of the present invention that includes forward-error-correction (FEC) circuits at the transmitter and receiver sections.

FIG. 5 is a schematic diagram of another embodiment of a a long haul optical communication system of the present invention that includes FEC circuits that operate lower speeds than the FIG. 3 embodiment.

### DETAILED DESCRIPTION OF THE PREFERRED EMBODIMENTS

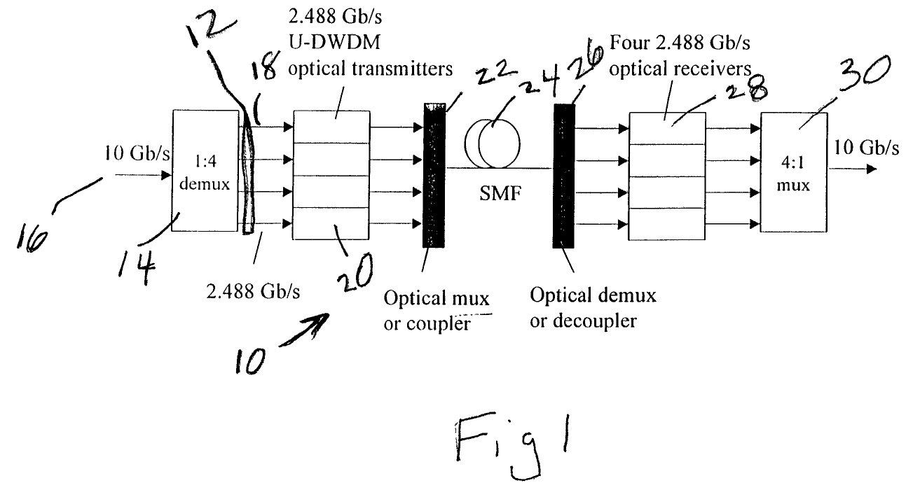

In various embodiments of the present invention, split wave methods and apparatus are provided for transmitting data in optical fiber systems, including but not limited to long haul optical fiber systems. Referring to FIG. 1, one embodiment of an optical communication system 10, of the present invention, includes an optical-to-electronic converter 12 and an electronic demultiplexer 14 that is configured to receive and split an optical input 16 into a plurality of sub-wavelengths 18. Optical input 16 has a first data rate.

A plurality of optical transmitters 20 is coupled to electronic demultiplexer 14. Electronic demultiplexer 14 can be a conventional time-division demultiplexer. Any number of optical transmitters 20 can be utilized, however, the number is optimized such that the physical space due to multiple transmitters can be minimized. Because the wavelength spacing between sub-wavelengths 18 can become very small, suitable optical transmitters 20 can include precise wavelength lockers to minimize or eliminate sub-wavelength drift due to changes in operation environment. Optical transmitters 20 transmit sub-wavelengths 18. Sub-wavelengths 18 are wavelength spaced sufficiently close with respect to each other to provide that the combined spectral efficiency for all sub-wavelengths 16 is close to or greater than the spectral efficiency of optical input 16. An optical multiplexer or coupler 22 transmits sub-wavelengths to an optical fiber 24 which can be a any form of single mode optical fibers, including but not limited to SMF-28, truewave, LEAF and the like. Optical multiplexer or coupler 22 combines all sub-wavelengths 18 and launches them together into optical fiber 24.

In various embodiment, and by way of illustration and without limitation, for N sub-wavelengths 16 there are N optical receivers 28 and an N:1 electronic multiplexer 30, and a 1:N electronic demultiplexer 14. If conventional baseband NRZ or RZ modulation is used, N optical transmitters 20 are provided.| In various embodiments, by way of illustration and without limitation, number of sub-wavelengths 16 is in the range of 4 to 32, and 4 to 16.

A total bandwidth occupied by sub-wavelength 16 can be within the same ITU window (grid) of optical input 16. Additionally, the total bandwidth occupied by sub-wavelengths 16 can be close to or less than the bandwidth occupied by optical input 16. In one embodiment, by way of illustration and without limitation, the total bandwidth occupied by sub-wavelengths 16 is about 5 times or less than the bandwidth occupied by optical input 16.

An optical demultiplexer or coupler 26 receives sub-wavelengths 16 from optical fiber 24 and passes them to a plurality of optical receivers 28. Suitable optical demultiplexers 26 include but are not limited to array-waveguide demultiplers based on silicon, or bulk grating-based demultiplexers. Suitable couplers 26 include but are not limited to fused fiber couplers, silicon-on-silica couplers, and the like. Transmitters 28 can be tunable or non-tunable. An electronic multiplexer 30, at the receiving end, can be included and positioned to receive sub-wavelengths 18 from receivers 28. Electronic multiplexer 30 converts data rates of sub-wavelengths 16 back to the first data rate of optical input 16.

In various embodiments of the present invention, different data rates can be utilized including but not limited to those listed in the following table which illustrates how an original high-speed data is split into different lower data-rate signals.

| | Split sub- | | |
|---|---|---|---|
| Original optical | wavelength data | # of sub- | Sub-wavelength |
| input data rate | rate | wavelengths | spacing |
| 10 Gb/s | 2.5 Gb/s | 4 | 3˜12.5 GHz |
| 40 Gb/s | 2.5 Gb/s | 16 | 3˜12.5 GHz |
| 40 Gb/s | 10 Gb/s | 4 | 6˜25 GHz |
| 80 Gb/s | 10 Gb/s | 8 | 5˜25 GHz |
| 80 Gb/s | 40 Gb/s | 2 | 20˜100 GHz |

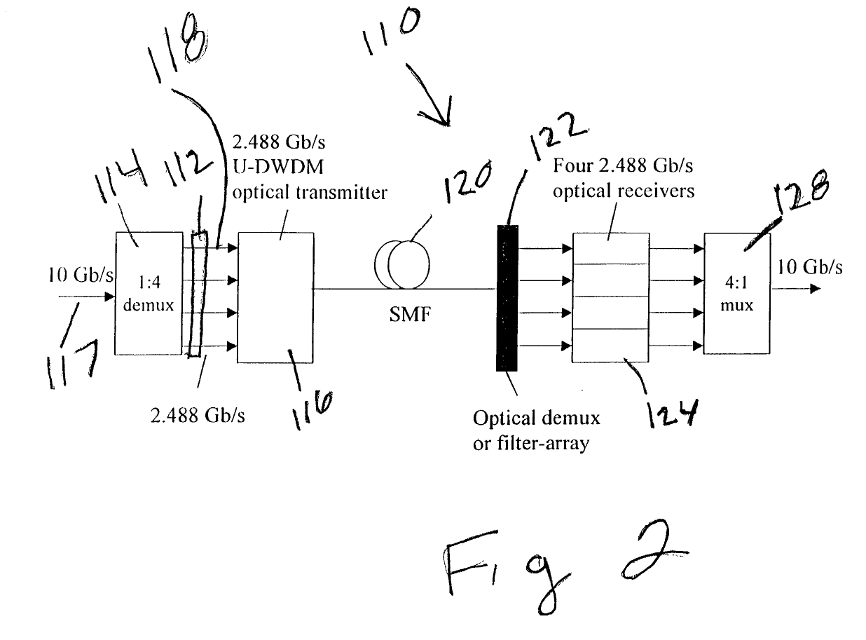

In another embodiment of the present invention, illustrated in FIG. 2, a long haul optical communication system 110 includes an optical-to-electronic converter 112 and an electronic demultiplexer 114. An optical transmitter 116, that has a common optical carrier, is coupled to electronic demultiplexer 114. In this embodiment, optical transmitter 116 uses optical demultiplexing to split an optical input 117 into multiple sub-wavelengths 118. In embodiment, neither multiple optical transmitters, nor multiplexer/coupler are required at the transmitting end.

If a special sub-carrier multiplexing modulation method, including but not limited to optical-single-sideband technique is used as disclosed in U.S. Ser. No., 09/575,811 and U.S. Ser. No. ______ filed Jan. 7, 2002 (Attorney Docket No. 26084-719), then a continuous-wave optical carrier can be sent through an external modulator. The multiple demultiplexed electronic signals are then used to modulate the external modulator and sub-wavelengths 118 are generated at the output of the external modulator. Sub-wavelengths 118 have the same characteristics as sub-wavelengths 16 described above.

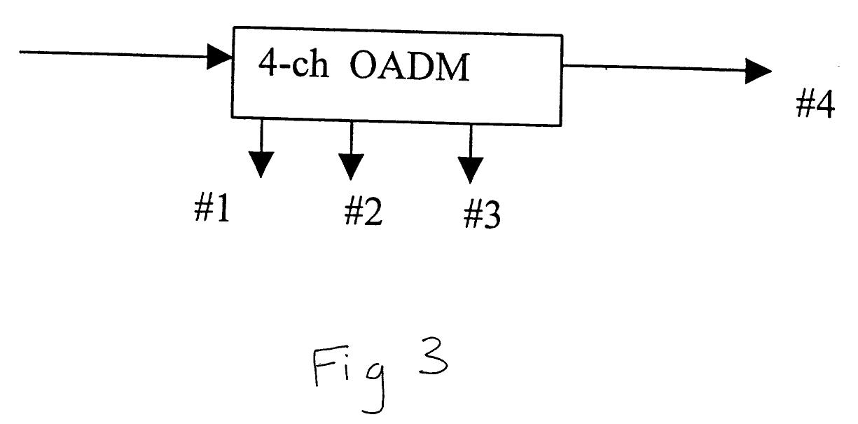

An optical fiber 120 couples transmitter 116 to an optical demultiplexer or splitter, and then to an array of optical filters 122. Each optical filter 122 is preferably narrow enough to extract each individual sub-wavelength 118 and sharp enough to minimize or avoid the crosstalk coming from adjacent channels. An alternative to optical filters 122 in combination with optical splitter is to use a multi-channel optical add-drop multiplexer (OADM), which can drop each individual sub-wavelength 118 in serial as illustrated in FIG. 3.

Referring again to FIG. 2, optical fiber 120 has the same characteristics as optical fiber 24 described above. A plurality of receivers 124 are positioned to receive sub-wavelengths 118 from electronic multiplexer or filter array 122. An electronic multiplexer 128 can be included and positioned to receive sub-wavelengths 118 from transmitters 124. Electronic multiplexer 128 converts data rates of sub-wavelengths 118 back to the original data rate of optical input 118.

Systems 10 and 110 significantly increase the non-dispersion shifted conventional single mode fiber transmission distance, by way of illustration and without limitation for example, beyond 700 km of a 10 Gb/s system, without using dispersion compensation devices. Systems 10 and 110 employ a small number of lower speed optical transmitters 20 and 116 to transport sub-wavelengths 18 and 118 in parallel rather than using a single high-speed optical transmitter. Optical transmitters 20 and 116 are closely spaced in wavelength for a number of reasons. If the bandwidth occupied by optical transmitters 20 and 116 is too large then there is a waste of bandwidth. By way of illustration and without limitation, a typical baseband NRZ 10 Gb/s data occupies a bandwidth of ˜20 GHz, while four 100 GHz-spaced 2.5 Gb/s data could occupy a total bandwidth of ˜100 GHz×(4−1)=300 GHz. This means that ˜14 times more bandwidth is wasted. However, when the channel spacing is decreased to 10 GHz, then the total bandwidth decreases to only 30 GHz.

Transmitters 20 and 116 can use U-DWDM wavelengths as disclosed in U.S. patent applications Ser. No. 703 and the last one, that are spaced sufficiently close to each other to decrease the bit skew due that results with parallel transmission at different wavelengths. If the wavelength spacing of the parallel bits is not small enough, then skew can become a problem in a long long-haul transmission system due to fiber chromatic dispersion. For example, if four channels are spaced by 0.8 nm, for a standard ITU grid, the total skew after 3000 km transmission through a conventional single-mode fiber can be as high as about 120 ns. However, using close spaced sub-wavelengths 18 and 118, for example 10 GHz-spaced U-DWDM channels, the total skew is decreased by ten times to only about 12 ns.

The methods and systems of the present invention can be applied to different inputs, including but not limited to a 40 Gb/s transmission. A 40 Gb/s signal can be split into four 10 Gb/s transmission, or sixteen 2.5 Gb/s transmission. A 40 Gb/s channel occupies a bandwidth of 80 GHz; four 20 GHz-spaced 10 Gb/s channel also occupy a bandwidth of 80 GHz. Sixteen 4.5 GHz-spaced 2.5 Gb/s occupy about 72 GHz which can still be within a 100 GHz ITU window. The total bandwidth is for all three examples in this paragraph. Therefore, when a higher data rate is split into lower data rate channels, the spectral efficiency can be kept almost equal by using U-DWDM techniques, while the transmission distance without dispersion compensation becomes much longer. A lower data rate channel, including but not limited to 2.5 Gb/s, can tolerate a much higher fiber dispersion. The maximum dispersion-limited transmission distance is inversely proportional to the square of data bit rate. A 2.5 Gb/s data rate channel can transmit through a distance that is 16 times longer than a 10 Gb/s data rate channel.

In another embodiment of the present invention forward error correction (FEC) circuit chips are utilized. FEC chips are utilized to improve the bit-error-rate performance and increase the transmission distance of systems of the present invention. In one specific embodiment, the bit-error-rate performance is improved from 10⁻⁴ to 10⁻¹¹.

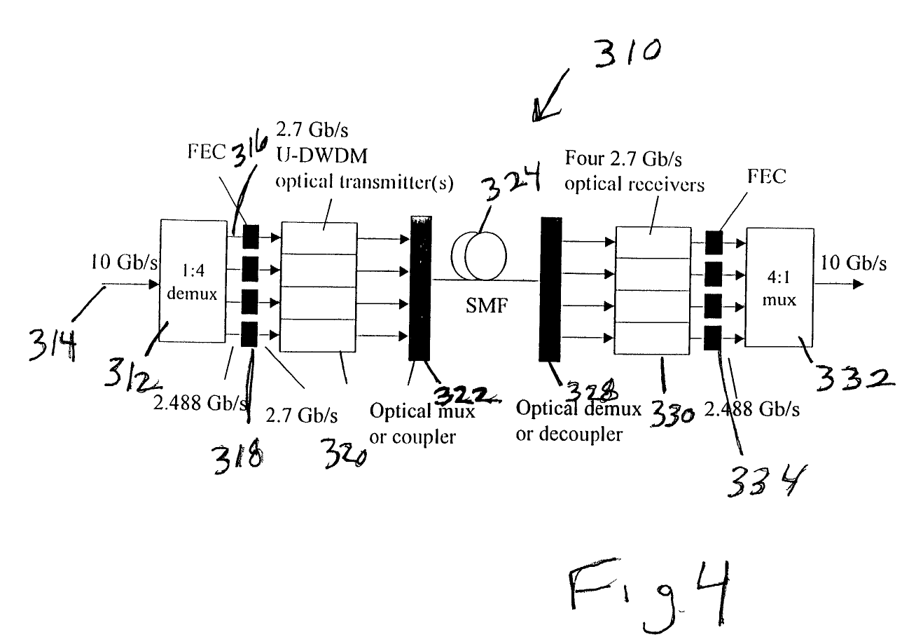

In FIG. 4, another embodiment of the present invention is an optical communication system 210 that includes a demultiplexer 212 which receives an optical input 214, a plurality of U-DWDM optical transmitters 216 coupled to a plurality of multiplexers 218 and a plurality of FEC circuits 220. The number of transmitters 216, multiplexers 218 are FEC circuits 220 is selected. FEC circuits 220 are used to increase transmission distance and to make system 210 more robust by improving the error-rate performance. FEC circuits 220 split the original data rate of optical input 214 into lower data rates. FEC circuits 220 provide split-wave methodology in electronics and use coding technology.

Optical fiber 226 is coupled to optical demultiplexer or decoupler 228 which in turn sends sub-wavelengths 224 to a plurality of optical receivers 230. A demultiplexer 232 converts data rates of sub-wavelengths 224 back to the original data rate of optical input 214. An electronic multiplexer 234 is coupled to receivers 230 and a plurality of FEC circuits 236 are coupled to demutiplexer 232 and demultiplexers 234. FEC circuits 220 at the transmitting end of system 210 are encoders while FEC circuits 220 at the the receiving end are decoders. In various embodiments, the bit-error-rate of system 210 can be 10⁻¹⁴ to 10⁻¹⁵ after FEC circuits 220 at the receiving end.

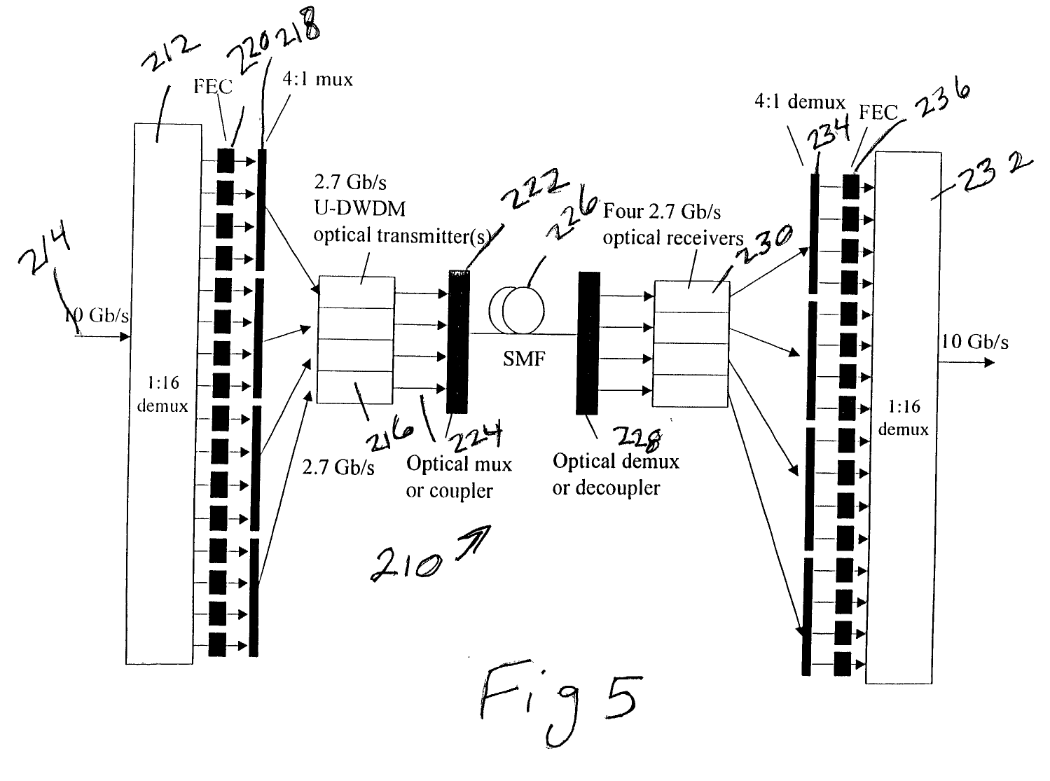

The embodiment of FIG. 5 is similar to system 210. As illustrated in FIG. 5, an optical communication system 210 includes a demultiplexer 312 that receives and splits an optical input 314 into a plurality of sub-wavelengths 316. A plurality of FEC circuits 318 and U-DWDM transmitters 320 are included. An optical multiplexer or coupler 322 is coupled to transmitters 320 and an optical fiber 324. At the receiver end of system 310, an optical demultiplexer or decoupler 328 is coupled to optical fiber 324 and a plurality of optical receivers 330. Again, a multiplexer 332 converts data rates of sub-wavelengths 316 back to the original data rate of optical input 314. A plurality of FEC circuits 334 are coupled to multiplexer 332 and receivers 330 In other embodiments of the present invention closed spaced sub-wavelengths can be produced with the use of an optical comb, as more fully disclosed in U.S. Pat. Nos. 6,163,553 and 6,008,931, both incorporated herein by reference The optical combs can be utilized in combination with an array of narrowband optical filters to filter out each comb. An array of external modulators is provided to respectively modulate the array of combs.

While the invention has been described in connection with what is presently considered to be the most practical and preferred embodiment, it is to be understood that the invention is not limited to the disclosed embodiment, but on the contrary it is intended to cover various modifications and equivalent arrangement included within the spirit and scope of the claims which follow.

What is claimed is:

We claim:

1. A method of transmitting optical signals in an optical communication system, comprising:
receiving an optical input that has a first data rate;
splitting the optical input into a plurality of sub-wavelengths, wherein the plurality of sub-wavelengths are spaced sufficiently close in wavelength to provide a spectral efficiency of all the sub-wavelengths of the plurality of sub-wavelengths that is close to or greater than a spectral efficiency of the optical input;
combining the plurality of sub-wavelengths.

2. The method of claim 1, wherein a total bandwidth occupied by the sub-wavelengths is within a same ITU window of the optical input.

3. The method of claim 2, wherein the total bandwidth occupied by the sub-wavelengths is less than a bandwidth occupied by the optical input.

4. The method of claim 2, wherein the total bandwidth occupied by the sub-wavelengths is 5 times or less than a bandwidth occupied by the optical input.

5. The method of claim 1, wherein the optical input is serial and the plurality of the transmitted sub-wavelengths are parallel.

6. The method of claim 1, wherein the sub-wavelengths are generated by demultiplexing the optical input into the plurality of sub-wavelengths.

7. The method of claim 6, wherein the sub-wavelengths are demultiplexed using all-optical demultiplexing.

8. The method of claim 6, wherein the sub-wavelengths are demultiplexed by demultiplexing the optical input into a plurality of electronic signals that one or more optical transmitters.

9. The method of claim 1, wherein a plurality of optical transmitters are provided to produce the plurality of sub-wavelengths, each of an optical transmitter including a wavelength locker.

10. The method of claim 1, wherein a single optical transmitters is provided and uses subcarrier multiplexed modulation to produce the plurality of sub-wavelengths.

11. The method of claim 1, wherein a single optical transmitters is provided and uses optical single side band modulation to produce the plurality of sub-wavelengths.

12. The method of claim 7, wherein the plurality of sub-wavelengths from a plurality of optical transmitters are combined by a multiplexer or an optical coupler.

13. The method of claim 12, wherein a plurality of optical receivers are provided, each of an optical receiver of the plurality of optical receivers being configured to receive a sub-wavelength.

14. The method of claim 13, wherein each of optical receiver includes one of an optical wavelength demultiplexer, an optical splitter, or an optical add-drop multiplexer that separates the plurality of sub-wavelengths.

15. The method of claim 14, wherein the plurality of sub-wavelengths are introduced to multiple fixed optical to electrical converters.

16. The method of claim 13, wherein a number of sub-wavelengths is equal to a number of optical receivers.

17. The method of claim 16, wherein a number of sub-wavelengths is in the range of 4 to 32

18. The method of claim 1, wherein the first data rate is 10 Gb/sec or more.

19. The method of claim 1, wherein a sub-wavelength data rate of each subwavelength 50 Gb/s or less, and spacing of the sub-wavelengths is 25 GHz or less.

20. The method of claim 1, wherein a sub-wavelength data rate of each subwavelength is 10 Gb/s or less, and spacing of the subwavelengths is in the range of 5 to about 25 GHz.

21. The method of claim 1, wherein a sub-wavelength data rate of each subwavelength is 10 Gb/s or less, and spacing of the subwavelengths is in the range of to about 6 to 25 GHz.

22. The method of claim 1, wherein a sub-wavelength data rate of each subwavelength is 2.5 Gb/s or less, and spacing of the subwavelengths is in the range of to about 3 to 12.5 GHz.

23. The method of claim 1, wherein a number of subwavelengths is 2 and a sub-wavelength spaceing is in the range of 20 to about 100 GHz.

24. The method of claim 1, wherein a number of subwavelengths is 8 and a sub-wavelength spaceing is in the range of 5 to about 25 GHz.

25. The method of claim 1, wherein a number of subwavelengths is 4 and a sub-wavelength spaceing is in the range of 6 to about 25 GHz.

26. The method of claim 1, wherein a number of subwavelengths is 16 and a sub-wavelength spaceing is in the range of 3 to about 12.5 GHz.

27. The method of claim 1, wherein a number of subwavelengths is 4 and a sub-wavelength spaceing is in the range of 3 to about 12.5 GHz.

28. A method of transmitting optical signals in an optical communication system, comprising:
receiving an optical input that has a first spectral efficiency;
splitting the optical input into a plurality of sub-wavelengths, wherein the plurality of sub-wavelengths have a combined spectral efficiency close to or greater than that the first spectral efficiency; and
combining the plurality of sub-wavelengths.

29. The method of claim 28, wherein a sub-wavelength data rate of each subwavelength is 10 Gb/s or less, and spacing of the subwavelengths is in the range of 5 to about 25 GHz.

30. The method of claim 28, wherein a sub-wavelength data rate of each subwavelength is 10 Gb/s or less, and spacing of the subwavelengths is in the range of to about 6 to 25 GHz.

31. The method of claim 28, wherein a sub-wavelength data rate of each subwavelength is 2.5 Gb/s or less, and spacing of the subwavelengths is in the range of to about 3 to 12.5 GHz.

32. A method of transmitting optical signals in an optical communication system, comprising:
receiving an optical input that has a first data rate;
splitting the optical input into a plurality of sub-wavelengths, wherein each of a sub-wavelength of the plurality of sub-wavelengths is in a single ITU window; and
combining the plurality of sub-wavelengths.

33. A long haul optical communication system, comprising:
a first optical-to-electronic converter and a first electronic demultiplexer configured to receive and split an optical input into a plurality of sub-wavelengths, the optical input having a first data rate;
a plurality of optical transmitters coupled to the first electronic demultiplexer, wherein the plurality of optical transmitters are configured to transmit the plurality of sub-wavelengths with a wavelength spacing sufficiently close to provide a spectral efficiency of all the sub-wavelengths of the plurality of sub-wavelengths close to or greater than a spectral efficiency of the optical input;
a first optical multiplexer or first coupler;
a second optical demultiplexer, splitter or an OADM; and
a plurality of receivers coupled to the optical multiplexer or splitter and the first optical multiplexer or first coupler.

34. The system of claim 33 further comprising:
a second electronic multiplexer coupled to the plurality of receivers and configured to convert data rates of the plurality sub-wavelengths back to the first data rate.

35. The system of claim 33, wherein the first data rate is 10 Gb/sec or more.

36. The system of claim 33, wherein the plurality of receivers is wavelength-tunable.

37. The system of claim 33, wherein the plurality of receivers is not wavelength-tunable.

38. The system of claim 33, wherein a number of sub-wavelengths equals a number of receivers.

39. The system of claim 33, wherein a number of sub-wavelengths equals a number demultiplexed electronic signals.

40. The system of claim 33, wherein a total bandwidth occupied by the sub-wavelengths is within a same ITU window of the optical input.

41. The system of claim 40, wherein the total bandwidth occupied by the sub-wavelengths is less than a bandwidth occupied by the optical input.

42. The system of claim 40, wherein the total bandwidth occupied by the sub-wavelengths is about 5 times or less than a bandwidth occupied by the optical input.

43. A long haul optical communication system, comprising:
a first optical-to-electronic converter and a first electronic demultiplexer;
an optical transmitter with a common optical carrier coupled to the first electronic demultiplexer, the optical transmitter being configured to modulate the common optical carrier by using demultiplexed electronic signals and splitting an optical input with a first data rate into a plurality of sub-wavelengths, wherein sub-wavelengths of the plurality of sub-wavelengths each have a spectral efficiency close to or greater than a spectral efficiency of the optical input;
an optical demultiplexer or optical splitter;
a second electronic multiplexer; and
a plurality of receivers positioned to receive input from the optical demultiplexer or the optical splitter and produce an output that is coupled to the second electronic multiplexer.

44. The system of claim 43, wherein the first data rate is 10 Gb/sec or more.

45. The system of claim 43, wherein the plurality of receivers is wavelength-tunable.

46. The system of claim 43, wherein the plurality of receivers is not wavelength-tunable.

47. The system of claim 43, wherein a number of sub-wavelengths equals a number of receivers.

48. The system of claim 43, wherein a number of sub-wavelengths equals a number demultiplexed electronic signals.

49. The system of claim 43, wherein a total bandwidth occupied by the sub-wavelengths is within a same ITU window of the optical input.

50. The system of claim 49, wherein the total bandwidth occupied by the sub-wavelengths is less than a bandwidth occupied by the optical input.

51. The system of claim 49, wherein the total bandwidth occupied by the sub-wavelengths is about 5 times or less than a bandwidth occupied by the optical input
